(19) United States
(12) Patent Application Publication
(10) Pub. No.: US 2007/0008650 A1
(43) Pub. Date: Jan. 11, 2007

(54) Head slider and information storage apparatus

(75) Inventors: Kenzo Nakamura, Kawasaki (JP); Takeshi Ohwe, Kawasaki (JP); Toru Watanabe, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/284,405

(22) Filed: Nov. 22, 2005

(30) Foreign Application Priority Data
Jul. 11, 2005 (JP) 2005-202011

(51) Int. Cl. G11B 5/60

(52) U.S. Cl. 360/234.3

(57) ABSTRACT

The present invention provides a high-safety head slider and an information storage apparatus having high operational reliability. The present invention provides a head slider equipped with a head that accesses a movable information storage medium on which information is recorded and that implements at least information reproduction, and situated close to the information storage medium. The head slider includes: a floating force generating section, opposing the information storage medium, that generates floating force upward from the information storage medium, through movement of the information storage medium; and a base section, equipped with the head, that, through floating force generated by the floating force generating section, floats from the information storage medium, the thickness in the floating direction of the base section varying along the direction of movement of the information storage medium.

### BACKGROUND OF THE INVENTION

1. Field of the Invention

The present invention relates to a head slider on which a head for accessing an information storage medium is mounted, and to an information storage apparatus utilizing the head slider.

2. Description of the Related Art

To date, information storage apparatuses such as a magnetic disc apparatus and a magnet-optical storage apparatus have been known; in these information storage apparatuses, information is recorded on a rotatable disk-like information storage medium. In addition, head sliders have been known that, in these information storage apparatuses, carry a head for accessing an information storage medium, and float above and close to the surface of information storage medium.

In general, a head slider is configured of a floating force generating section that faces the surface of an information storage medium and, through the airflow due to rotation of an information storage medium, creates floating force and a base section that floats by means of the floating force. With regard to the shape of the floating force generating section, diverse contrivances for obtaining stable properties of floating have been proposed (e.g., Japanese Patent Laid-Open No. 2000-173215, Japanese Patent Laid-Open No. 2000-260144, Japanese Patent Laid-Open No. 2001-014823, Japanese Patent Laid-Open No. 2001-155459, and Japanese Patent Laid-Open No. 2001-297421).

However, in recent years, the rotation speed of the information storage medium has been raised to faster than 15000 rpm; therefore, while the head slider follows a plane wobble (disc flutter) of the information storage medium, the head slider is agitated by the airflow hitting the base section, whereby the vicinities of the head slider may make a contact with the information storage medium.

In addition, some recent magnetic disc apparatuses are equipped with a loading/unloading mechanism with which, during the non-accessing duration, the head slider is situated at the shunting position that is apart from the top surface of the information storage medium; when the head slider, which has been shunted by the loading/unloading mechanism, returns to a position above the top surface of the information storage medium, the head slider is required to return without damaging the top surface of the information storage medium. However, if, during the returning duration, the posture of the head slider is not appropriate, the head slider may touch the top surface of the information storage medium, due to the airflow.

The operational reliability of an information storage apparatus whose head slider may make such a contact is low.

### SUMMARY OF THE INVENTION

The present invention has been made in view of the above circumstances and provides a high-safety head slider and an information storage apparatus having high operational reliability.

The present invention provides a head slider equipped with a head that accesses a movable information storage medium on which information is recorded and that implements at least information reproduction, and situated close to the information storage medium, the head slider including: a floating force generating section, opposing the information storage medium, that generates floating force upward from the information storage medium, through movement of the information storage medium; and a base section, equipped with the head, that, through floating force generated by the floating force generating section, floats from the information storage medium, the thickness in the floating direction of the base section varying along the direction of movement of the information storage medium.

According to a head slider of the present invention, because the thickness of the base section varies along the direction of movement of the information storage medium, the thickness at the position where, due to agitation by the airflow, the head slider is likely to touch the information storage medium, can be reduced, whereby high safety is secured.

It is preferable that, at an upstream position of a movement flow of the information storage medium, the thickness of the base section of a head slider according to the present invention is smaller than that at a downstream position thereof.

Because the thickness of the head slider is small at an upper position of the movement flow, the airflow can appropriately be withstood, whereby a contact with the information storage medium can be avoided.

An information storage apparatus according to the present invention includes: a head slider equipped with a head that accesses a movable information storage medium on which information is recorded and that implements at least information reproduction, and situated close to the information storage medium, the head slider including: a floating force generating section, opposing the top surface of the information storage medium, that generates floating force upward from the information storage medium, through movement of the information storage medium; and a base section, equipped with the head, that, through floating force generated by the floating force generating section, floats from the information storage medium, the thickness in the floating direction of the base section varying along the direction of movement of the information storage medium; a medium holding section that causes the movement of the information storage medium, by holding and rotating the information storage medium; and a slider moving section that holds the head slider and moves the head slider in a direction crossing the movement direction of the information storage medium.

According to the information storage apparatus of the present invention, the safety of the head slider is high, whereby the operational reliability is high.

In the most typical mode of the information storage apparatus according to the present invention, the slider moving section includes: an arm, having a rotation axis at a base thereof, that extends along the information storage medium; an actuator that makes the arm pivot about the rotation axis; and a protrusive section, carrying the head slider, that protrudes from the arm and extends toward the base of the arm. In the most typical mode, it is preferable that, at the frontward side of the protrusive section, the thickness of the base section of the head slider is smaller than that at the rearward side thereof.

The frontward side of the gimbal is readily agitated by the airflow; therefore, if the thickness of the frontward side thereof is small, the safety of the head slider is high, whereby the operational reliability is high.

As described heretofore, according to the present invention, a high-safety head slider and an information storage apparatus having high operational reliability can be obtained.

### BRIEF DESCRIPTION OF THE DRAWINGS

FIG. 1 is a schematic plan view of a magnetic disc apparatus corresponding to the first embodiment of an information storage apparatus according to the present invention;

FIG. 2 is a detailed view of the vicinities of a head slider;

FIG. 3 is a view illustrating a comparative example;

FIG. 4 is a view illustrating the shape of a head slider according to the first embodiment;

FIG. 5 is a view illustrating the shape of a head slider according to the second embodiment; and

FIG. 6 is a view illustrating the shape of a head slider according to the third embodiment.

### DETAILED DESCRIPTION OF THE INVENTION

Embodiments of the present invention will be explained below, with reference to the drawings.

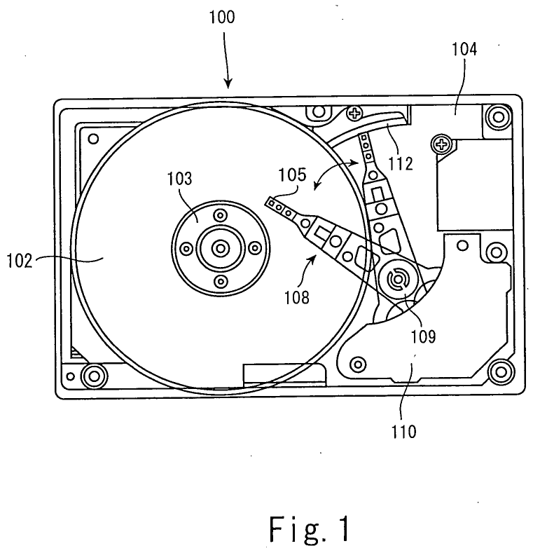

FIG. 1 is a schematic plan view of a magnetic disc apparatus corresponding to the first embodiment of the information storage apparatus according to the present invention.

A magnetic disc apparatus 100 illustrated in FIG. 1 is utilized being connected to, or being incorporated in, a mainframe computer, a personal computer, or the like, and is equipped with a loading/unloading mechanism.

In the magnetic disc apparatus 100, a spindle motor 103 for driving a magnetic disc 102 the magnetic disc 102 is a kind of information storage medium according to the present invention by rotating it is mounted on a base plate 104 that supports constituent components of the magnetic disc apparatus 100. The spindle motor 103 corresponds to an example of the medium holding section according to the present invention.

The magnetic disc 102 is mounted on the rotation axis of the spindle motor 103 and is driven by the spindle motor 103, counterclockwise in FIG. 1 and at a predetermined pivoting speed. In general, a magnetic disc apparatus is equipped with one or more magnetic discs, in accordance with an application; in the magnetic disc apparatus 100 illustrated in FIG. 1, two magnetic discs 102 are mounted on the pivotal axle of the spindle motor 103. In FIG. 1, the magnetic disc 102 as a first magnetic disk mounted on the pivotal axle of the spindle motor 103 is illustrated; an unillustrated second magnetic disc is mounted below (behind the disk 102 shown in FIG. 1) and spaced apart from the first magnetic disc 102.

A head slider 105 on which a magnetic head is mounted that implements recording and playback of information with respect to the magnetic disc 102, is fixed through a gimbal described later to the front end of a carriage arm 108; the head slider 105 is situated close to the top surface of the magnetic disc 102, being supported by the carriage arm 108. In the magnetic disc apparatus 100, four carriage arms 108 are provided for four respective recording/playback sides corresponding to the front and rear sides of the two magnetic discs 102; the four carriage arms 108 are mounted on a common arm axel 109 and are rotated by an actuator 110. The head slider 105 corresponds to one embodiment of the head slider according to the present invention; the carriage arm 108 (and part of the gimbal described later) corresponds to an example of the arm according to the present invention; the actuator 110 corresponds to an example of the actuator according to the present invention. In addition, the carriage arm 108, the actuator 110, and the gimbal described later configure an example of the slider moving section according to the present invention.

With the four carriage arms 108 being rotated by the actuator 110, the head slider 105 travels along the top surface of the magnetic disc 102. Additionally, the range of travel of the head slider 105, through the actuator 110, extends to a shunting position off the magnetic disc 102; when the actuator 110 moves the head slider 105 to the shunting position, the front edge of the carriage arm 108 slides across a lamp 112, whereby the head slider 105 is pushed out of the top surface of the magnetic disc 102.

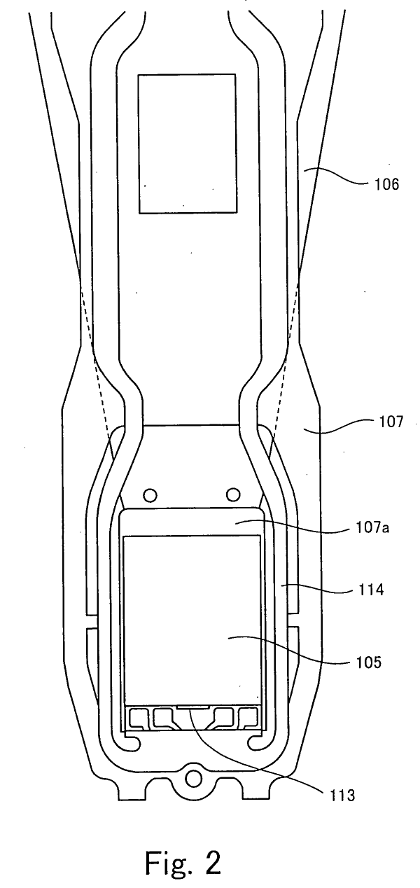

FIG. 2 is a detailed view of the vicinities of the head slider 105.

FIG. 2 illustrates the appearance of the head slider 105 when viewed from the magnetic disc. The front edge of the carriage arm 108 illustrated in FIG. 1 is a shrinking load beam 106 to which a gimbal 107 formed of a SAS plate is welded. On the gimbal 107, a tongue section 107a is provided that protrudes, as being folded back, from the front edge side to the base side (i.e., the base of the carriage arm 108), of the load beam 106; the head slider 105 is mounted on the tongue section 107a. In addition, the tongue section 107a makes a point-like contact with a dimple, described later, that is provided on the load beam 106. On the head slider 105, a magnetic head 113 is mounted that accesses the magnetic disc and implements reading and writing of information; to the magnetic head 113, an electric lead 114 is connected that communicates a writing signal and a read-out signal to the magnetic head 113.

In this situation, the tongue section 107a corresponds to an example of the protrusive section according to the present invention; the gimbal 107 excluding the tongue section 107a and the carriage arm 108 including the load beam 106 configure an example of the arm according to the present invention.

On the occasion of explaining further in detail the vicinities of the head slider 105, in the first place, a comparative example will be explained that has a head slider whose shape is different from those of head sliders in embodiments of the present invention; thereafter, embodiments of the present invention will be explained.

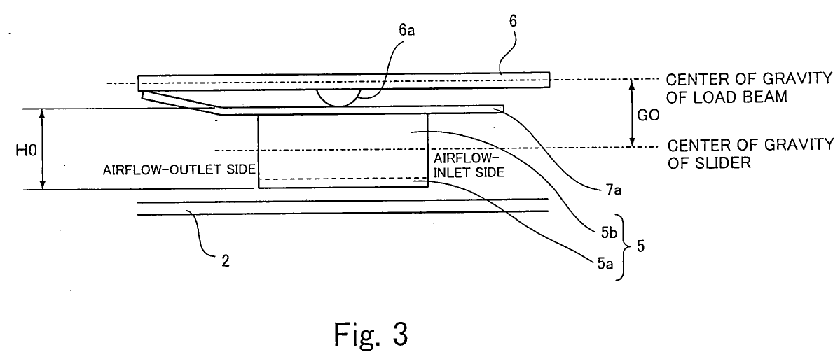

FIG. 3 is a view illustrating a comparative example.

FIG. 3 illustrates the appearance of a head slider 5 when viewed from the side of a load beam 6; the head slider 5 is mounted on a tongue section 7a, of a gimbal, that is supported on the vertex of a semispherical dimple 6a provided in the load beam 6.

The head slider 5 illustrated in FIG. 3 is configured of a floating force generating section 5a opposing a magnetic disc 2 and a base section 5b bonded to the tongue section 7a; a magnetic head (unillustrated) is disposed on the left side, among the sides, of the base section 5b.

Due to a rotation drive, the top surface of the magnetic disc 2 moves to left-hand side of FIG. 3; an air flow caused by the movement of the top surface flows from the right-hand side of FIG. 3 into the floating force generating section 5a of the head slider 5. The floating force generating section 5a is of a sleigh-like structure and, through interaction with the incoming airflow, generates floating force which acts upward from the top surface of the magnetic disc 2. Regardless of the direction of the gravity, the floating force has a direction parting from the top surface of the magnetic disc 2; in general, the condition in which, through the airflow, the head slider 5 is spaced a certain distance apart from the top surface of the magnetic disc 2 is termed “float”.

Disc flutter of the magnetic disc 2 is likely to be caused by a rotation drive; however, because the tongue section 7a on which the head slider 5 is mounted is supported on the vertex of the dimple 6a of the load beam 6, there is a degree of freedom for the direction of the head slider 5, whereby, even though disc flutter occurs, the head slider 5 can roll, while following the gradient of the top surface of the magnetic disc 2.

In the comparative example illustrated in FIG. 3, the base section 5b of the head slider 5 is of a shape of a simple rectangular parallelepiped and has a thickness necessary for carrying a magnetic head; the base section 5b floats by means of the floating force created by the floating force generating section 5a. In the comparative example, because the height H0, of the head slider 5, from the dimple 6a is large, the head slider 5 receives strong force caused by the airflow; therefore, if, due to occurrence of a large disc flutter, the head slider 5 significantly rolls, a condition may be caused in which the tongue section 7a is agitated by the airflow, thereby touching the load beam 6. In addition, in the comparative example, because the distance G0 between the center of gravity of the head slider 5 and the center of gravity of the load beam 6 is long, the main resonance frequency is low; therefore, if, due to some causes, the head slider 5 rolls, it takes a long time for the head slider 5 to return to the previous position, whereby an off-track error may be caused.

In contrast to the comparative example, in each of embodiments of the present invention, a contrivance has been made with regard to the shape of the base section of a head slider.

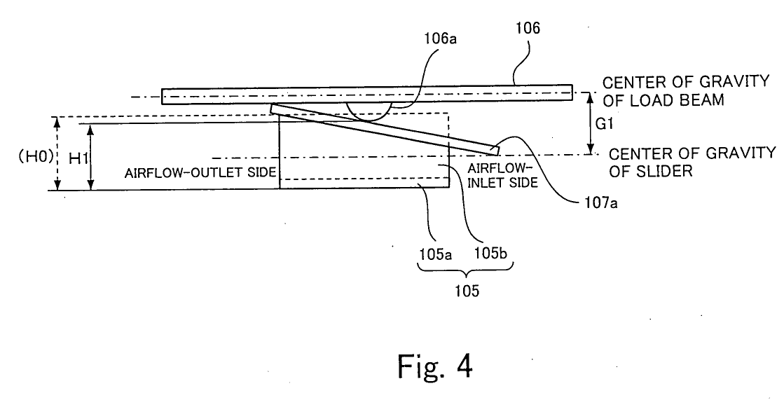

FIG. 4 is a view illustrating the shape of a head slider according to the first embodiment.

FIG. 4 also illustrates the appearance of the head slider 105 when viewed from the side of the load beam 106.

The head slider 105 is configured of: a floating force generating section 105a that faces a magnetic disc and creates floating force; and a base section 105b that floats by means of the floating force created by the floating force generating section 105a; in the first embodiment, the closer to the front edge (i.e., the airflow-inlet side) of the tongue section 107a the base section 105b extends along the tongue section 107a, the smaller the thickness (a dimension in the vertical direction in FIG. 4) of the base section 105b becomes. Accordingly, the head slider 105 receives weak force caused by the airflow, whereby the amount of being agitated by the airflow is also small.

Moreover, the tongue section 107a on which the head slider 105 is mounted is supported on the vertex of a dimple 106a of the load beam 106; in the first embodiment, the front end of the tongue section 107a extends obliquely downward in such a way as to part from the load beam 106. Accordingly, even through the head slider 105 is agitated to some extent by the airflow, the tongue section 107a and the load beam 106 may be less likely to touch each other.

Still moreover, the head slider 105 secures at the airflow-outlet side its height H1, from the dimple 106a, that is a thickness necessary to carry a magnetic head; however, the height H1 is smaller than the height H0 of the comparative example. Thus, even though the head slider 105 rolls, the magnetic-head travel distance with respect to the magnetic disc is shorter than that in the case of the comparative example, whereby the off-track error is also smaller than that in the case of the comparative example.

Furthermore, because the distance G1 between the center of gravity of the head slider 105 and the center of gravity of the load beam 106 is short, the main resonance frequency is high; therefore, even if the head slider 105 wobbles, the wobble quickly ceases. Due to a synergistic effect of the high main resonance frequency and the foregoing small amount of agitation caused by the airflow, even though, for example, when the head slider 105 returns through a loading/unloading mechanism from the shunting position to a position above the magnetic disc, a significant wobble occurs, there is no fear that the head slider 105 touches the magnetic disc.

As described above, the head slider 105 illustrated in FIG. 4 is high-safety, whereby the operational reliability of the magnetic disc apparatus 100 illustrated in FIG. 1 is high.

Other embodiments of the present invention will be explained below.

Magnetic disc apparatuses, according to other embodiments, that will be explained below are approximately the same as the foregoing magnetic disc apparatus according to the first embodiment, except for the shape of a head slider; therefore, only the vicinities of each of the head sliders will be explained, while omitting duplicate descriptions.

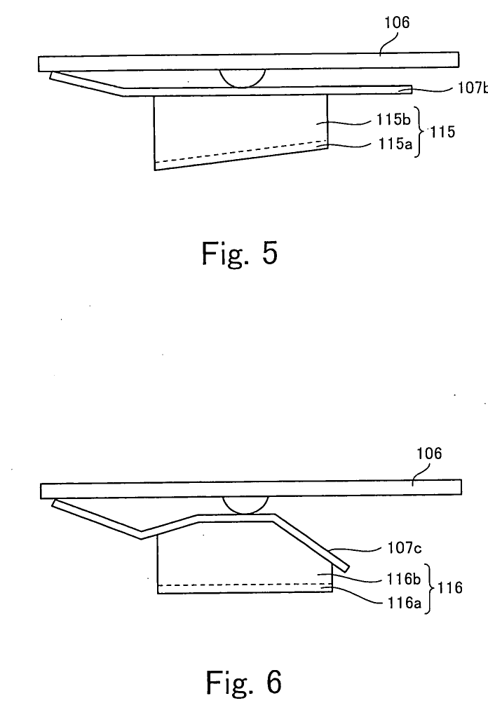

FIG. 5 is a view illustrating the shape of a head slider according to the second embodiment.

FIG. 5 also illustrates the appearance of a head slider 115 when viewed from the side of the load beam 106.

Also in the second embodiment, the head slider 115 is configured of a floating force generating section 115a and a base section 115b; the closer to the front edge (i.e., the airflow-inlet side) of a tongue section 107b the base section 115b extends along the tongue section 107b, the smaller the thickness (a dimension in the vertical direction in FIG. 5) of the base section 105b becomes. Accordingly, the head slider 115 receives weak force caused by the airflow, whereby the amount of being agitated by the airflow is small.

In addition, in the second embodiment, the tongue section 107b on which the head slider 115 is mounted extends in parallel with the load beam 106. Accordingly, in FIG. 5, the floating force generating section 115a of the head slider 115 has a right-up slope in such a way that the right end (i.e., the airflow-inlet side of the floating force generating section 115a and the front-end side of the tongue section 107b) of the floating force generating section 115a parts from the magnetic disc. In consequence, even though, when the head slider 115 returns through a loading/unloading mechanism from the shunting position to a position above the magnetic disc, a relatively large wobble occurs, the head slider 115 is never agitated by the airflow toward the magnetic disc, whereby the head slider 115 can safely return to a position above the magnetic disc, without damaging the magnetic disc.

As described above, the head slider 115 illustrated in FIG. 5 is high-safety, whereby the operational reliability of a magnetic disc apparatus according to the second embodiment is high.

FIG. 6 is a view illustrating the shape of a head slider according to the third embodiment.

FIG. 6 also illustrates the appearance of a head slider 116 when viewed from the side of the load beam 106.

The head slider 116 according to the third embodiment is also configured of a floating force generating section 116a and a base section 116b; in the third embodiment, the thickness (a dimension in the vertical direction in FIG. 6) of the base section 116b is small at both ends and large in the middle. In addition, a tongue section 107c on which the head slider 116 is mounted has such a shape that the floating force generating section 116a of the head slider 116 is in parallel with the top surface of the magnetic disc.

Also in the case of the structure, because the airflow-inlet-side (the right-hand side of FIG. 6) end of the head slider 116 is thin, the head slider 116 receives weak force caused by the airflow, whereby the amount of being agitated by the airflow is also small. Accordingly, the head slider 116 according to the third embodiment is also high-safety, whereby the operational reliability of a magnetic disc apparatus according to the third embodiment is high.

This concludes the explanation for the embodiments of the present invention.

In addition, in the above explanation, as an embodiment of the present invention, a magnetic disc apparatus on and from which information is written and read out has been described; however, the present invention can also be applied to an information storage apparatus utilizing an MO disc or a DVD as an information storage medium according to the present invention. In the case where the present invention is applied in that way, an optical head or the like is mounted on a head slider.

What is claimed is:

1. A head slider equipped with a head that accesses a movable information storage medium on which information is recorded and that implements at least information reproduction, and situated close to the information storage medium, the head slider comprising:
a floating force generating section, opposing the information storage medium, that generates floating force upward from the information storage medium, through movement of the information storage medium; and
a base section, equipped with the head, that, through floating force generated by the floating force generating section, floats from the information storage medium, the thickness in the floating direction of the base section varying along the direction of movement of the information storage medium.

2. The head slider according to claim 1, wherein, at an upstream position of a movement flow of the information storage medium, the thickness of the base section is smaller than that at a lower downstream of the movement flow.

3. An information storage apparatus comprising:
a head slider equipped with a head that accesses a movable information storage medium on which information is recorded and that implements at least information reproduction, and situated close to the information storage medium, the head slider including:
a floating force generating section, opposing the top surface of the information storage medium, that generates floating force upward from the information storage medium, through movement of the information storage medium, and
a base section, equipped with the head, that, through floating force generated by the floating force generating section, floats from the information storage medium, the thickness in the floating direction of the base section varying along the direction of movement of the information storage medium;
a medium holding section that causes the movement of the information storage medium, by holding and rotating the information storage medium; and
a slider moving section that holds the head slider and moves the head slider in a direction crossing the movement direction of the information storage medium.

4. The information storage apparatus according to claim 3, wherein the slider moving section includes;
an arm, having a rotation axis at a base thereof, that extends along the information storage medium;
an actuator that makes the arm pivot on the rotation axis; and
a protrusive section, carrying the head slider, that protrudes from the arm and extends toward the base of the arm.

5. The information storage apparatus according to claim 4, wherein, at the frontward side of the protrusive section, the thickness of the base section of the head slider is smaller than that at the rearward side thereof.
